(19) United States
(12) Patent Application Publication
(10) Pub. No.: US 2003/0039593 A1
(43) Pub. Date: Feb. 27, 2003

(54) Tip magazine

(76) Inventors: Andreas Lesche, Jena (DE); Georg Schmidt, Wuppertal (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/089,284

(22) PCT Filed: Jul. 11, 2001
(86) PCT No.: PCT/DE01/02545

(51) Int. Cl. B01L 9/00

(52) U.S. Cl. 422/104

(57) ABSTRACT

Tip magazine in which a plurality of tips (5) are arranged so as to be suspended in a plane in a carrier plate and in a predetermined grid arrangement relative to one another, and in which the outlet openings located at the free ends of the tips are also oriented relative to one another in the predetermined grid arrangement by means of an orienting plate irrespective of shape deviations of the tips.

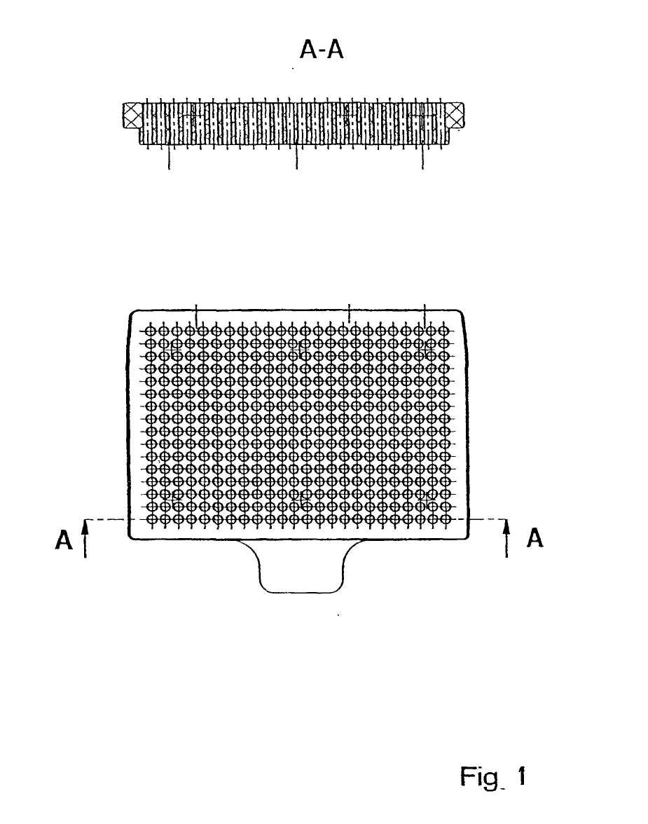

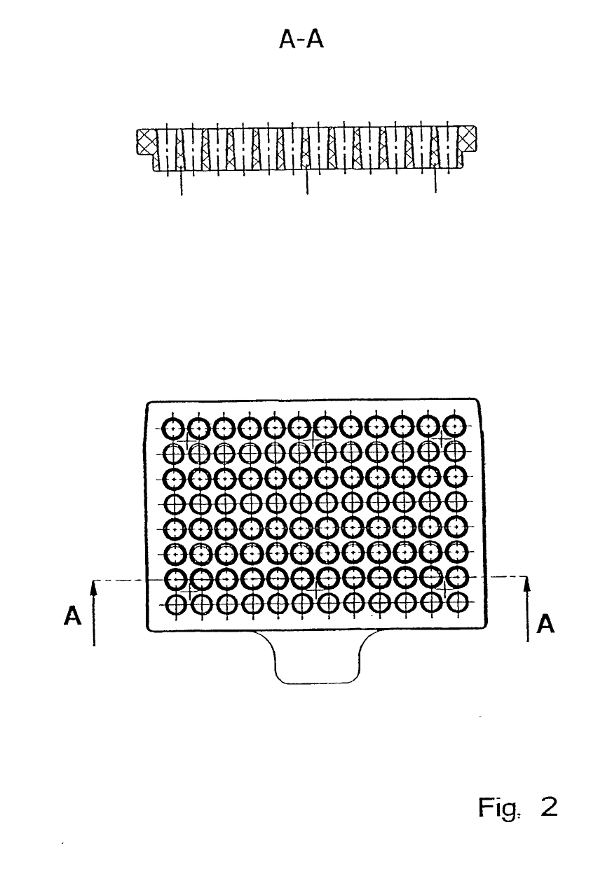

The invention is directed to a tip magazine, shown in FIGS. 1 and 2, in which a plurality of tips are arranged so as to be suspended in a plane in a predetermined grid relative to one another, such as is offered by the firm CyBio AG.

The multichannel pipetting devices known in the art can be distinguished from one another, based on the connection of the pipettes arranged in the pipetting head with the associated pipette tips (tips), principally as those with a frictional-positive connection between the pipetting channels and receiving openings of the tips and those with a purely frictional connection between the latter.

In the known pipetting devices with a frictional-positive connection, the connection elements of the pipetting channels are conical (outer cone). The tips, whose receiving openings are formed as an inner cone, are pushed onto the outer cone. In order to achieve a tight connection between the tips and the pipettes arranged in the pipetting head, the inner cone of the tips is often provided, in addition, with one or more sealing lips which press firmly on the outer cone of the pipettes. There are also known solutions in which the tips are pressed onto an outer cone or outer cylinder provided with an O-ring by a smooth inner cone or inner cylinder. The orientation or alignment of the tips depends on the exact fit on the outer cone. Deviations in the shape of the tips (in this case and in the following, by way of simplification, this is understood to mean only a curvature of the tip axis) are critical insofar as the drop detaching from the tip outlet opening does not fall into the center of the depression (well) associated with it in the microtitration plate arranged below it.

Producing and undoing a connection of this kind requires an extensive expenditure of energy which increases in proportion to the quantity of tips. Therefore, the connection technique described above is well-suited for pipetting devices with, e.g., eight pipettes arranged in a row, but is difficult to master for the pipetting devices with 96 tips (8×12) that are currently in widespread use.

On the other hand, a purely frictional connection, such as is known from the German Utility Model G 92 04 388.7, has been shown to be suitable in practice for pipetting heads with 384 tips (16×24), also. The CyBi-Well 384 automatic pipetting system produced by the firm CyBio AG has a pipetting head with 384 pipettes whose receiving openings open into a plane surface oriented vertical to the pipetting channel axis. A plate-shaped elastomer seal having openings corresponding to the grid of the pipetting channels is placed on the plane surface of all pipetting channels which are situated in a plane. A collar with annular end faces is formed on the tips around the receiving openings. In this regard, the shape of the outer surface of the collar is unimportant. This shape may be configured in a variety of ways ranging from cylindrical to individually formed ribs. The tips are pressed against the plate-shaped elastomer seal by means of a tip magazine in which the tips are arranged so as to be suspended by their collars in the same grid as the pipetting channels. For purposes of positioning the receiving openings relative to the pipetting channels, the fitted tip magazine is inserted up to a stop in a slide guide located below the pipetting channels and is subsequently fixed by means of eccentrics or cams. The tip magazine can be removed again by disengaging the eccentric in a simple manner.

Also, with this connection technique, a further increase in the quantity of tips arranged at the pipetting head on the same surface is only possible to a limited extent due to the required minimum cross section of the pipettes and tips.

The quantity of wells in the microtitration plates (MTP) or deep well blocks, as they are called, which are filled by the pipetting device can be increased by a simpler technique which also conforms to the trend toward smaller specimen amounts. The CyBi-Well 384/1536 automatic pipetting system is provided for more than two plate formats. It can fill a 384-format MTP in less than 20 seconds in a single work step and a 1536-format MTP in only 30 second in four work steps. Besides a highly accurate precision mechanism which ensures an exact positioning of the tip axes with respect to the center of the associated well, this technique requires that the tips are not bent, i.e., the tip axes must extend in a straight line.

Dimensionally stable tips of this kind are difficult to produce and, because of the high demand for disposable articles, represent a considerable cost factor.

All of the tip magazines offered by CyBio AG are highly flat, plane parallel plates which differ essentially only by the quantity and diameter of the holes depending on the type, quantity and size of the tips to be fitted. Insofar as they are not in the ideal straight shape, the tips are forced at a maximum into their ideal shape in an area directly below the collar when inserting into the tip magazine.

With tip magazines having cylindrical holes, as is shown in FIG. 1, the diameter of the holes is smaller than the collar diameter of the tips and at least as great as the greatest tip diameter, i.e., the greatest diameter below the collar.

For tip magazines with approximately conical holes, as shown in FIG. 2, the diameter of the hole is adapted approximately to the cross section of the tip below the collar.

These tip magazines serve only as aids for positioning the tips in a predetermined grid and simultaneously pressing them against the pipetting channels.

It is not possible to orient the free ends of the tips, and therefore the outlet openings, to the well centers, so that only high-quality tips without deviations in shape can be used, particularly for pipetting in very small wells.

It is the object of the invention to provide a tip magazine which orients the free ends of the tips suspended therein in a predetermined reference position so that even lower-quality tips with format deviations can be used for highly precise pipetting.

This object is met for a tip magazine according to the preamble of claim 1 in that a plane-parallel orienting plate is provided which is oriented parallel to the carrier plate at a distance L2 from the carrier plate and in that the orienting plate has the same quantity of through-holes in the same grid pattern as, and with a smaller cross section than, the through-holes of the carrier plate.

Depending on the thickness of the two plates and the overall length L1 of the tips, excluding the collar width, the plates have a distance L2 from one another, so that the tips are guided at close as possible to their free ends through the orienting plate. In this connection, “as close as possible to their free ends” means at a distance to the free end such that the tips can penetrate without hindrance into vessels for receiving reagents or for washing.

The tip magazine is accorded an additional function by the orienting plate, namely, that of orienting the free tip ends corresponding to the grid. The tip magazine according to the invention makes it possible to use tips of lower quality and therefore leads to a substantial reduction in cost. Due to the different combination of carrier plates and orienting plates with a different geometry and size of the through-holes and a different distance from one another, tip magazines which are adapted to a wide variety of tip shapes and tip dimensions can be prepared simply and quickly.

The invention will be described more fully in the following with reference to embodiment examples.

FIG. 1 shows a first tip magazine from the prior art;

FIG. 2 shows a second tip magazine from the prior art;

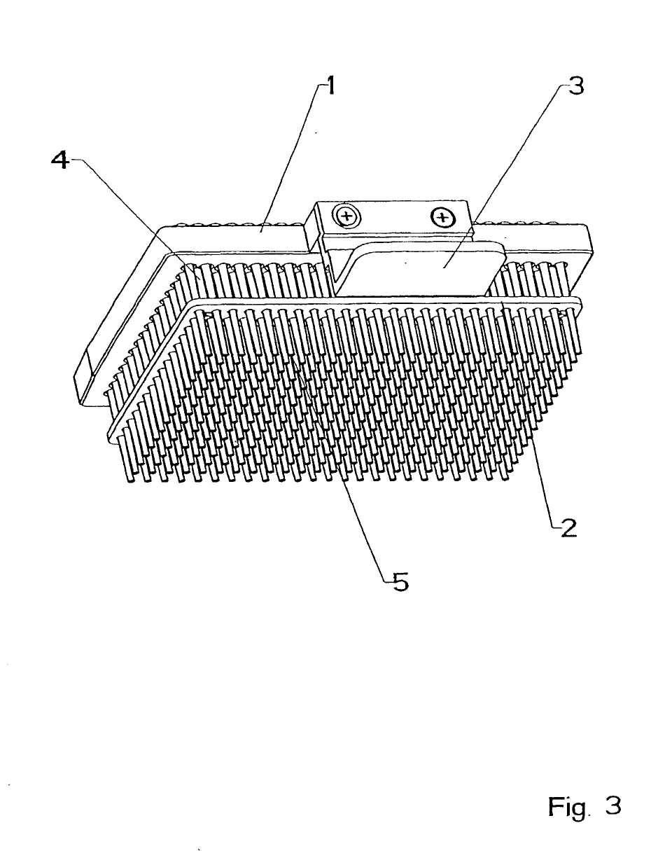

FIG. 3 shows a tip magazine according to the invention with rods as spacers;

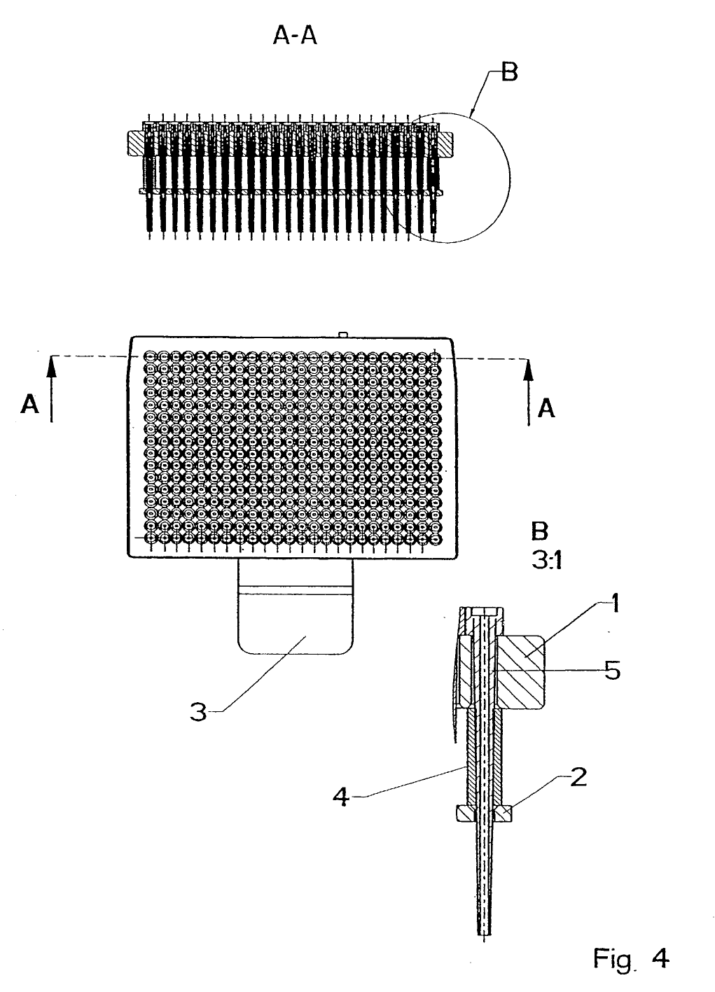

FIG. 4 shows a tip magazine according to the invention with sleeves as spacers.

FIG. 3 shows a tip magazine which substantially comprises a planeparallel carrier plate 1 with a plurality of through-holes (in this case, 384) arranged in a defined grid (in this case, 16×24), an orienting plate 2 with through-holes arranged in the same quantity and in the same grid as the through-holes of the carrier plate 1, a handle 3, and four spacers 4 of length L2 which are formed in this case as rods, each of which is connected with the carrier plate 1 and the orienting plate 2 so as to be centered between four holes. In the drawing, the tip magazine is filled with tips 5 of length L1 and it will be seen that the length L2 is selected such that half of the tip 5 is guided through the orienting plate 2 in the area toward the free end. How close the orienting plate 2 can be arranged to the free end of the tips 5 depends on the length by which the tips 5 are to penetrate into the vessel for receiving reagents or for washing.

Like the tip magazines known in the art, the carrier plate 1 functions in such a way that the tips 5 can be pressed against the pipetting channels simultaneously so as to lie in a defined grid spacing with the collar in the same plane in order to ensure tight connections between the pipetting channels and the tips 5. Accordingly, the carrier plate 1 must be manufactured precisely and so as to be extremely flat. Due to the orienting plate 2, the tip magazine has the additional function of orienting the tip ends. The through-holes in the carrier plate 1 and in the orienting plate 2 have a circular cross section and have the same diameter (with positive tolerance) as the inserted tips 5 in the guiding area.

In a modified variant, not shown in the drawing, the handle 3 is also connected with the orienting plate 2 and, together with only one additional rod arranged opposite to it, serves as a spacer 4.

FIG. 4 shows a tip magazine which differs from that shown in FIG. 3 in that the spacers 4 are sleeves. A variant of this kind is more advantageous for grid dimensions which are even smaller, since less space is required. Naturally, the spacers 4 can also be located in the edge area of the two plates.

In another embodiment example, not shown in the drawing, the through-holes in the orienting plate 2 have a rectangular cross section rather than a circular cross section. The equilateral triangular shape is advantageous in that the position of the tip ends which are guided through and which usually have a conical shape is determined by a three-point contact in the orienting plate.

Spacers 4 are not compulsory. The distance L2 between the carrier plate 1 and the orienting plate 2 can also be realized in that the orienting plate 2 is held at the tips S in a frictional engagement at a distance L2 from the carrier plate.

Of course, the through-holes in the carrier plate 1 and orienting plate 2 can also be adapted to deviations of the normally circular cross section of the tips 5.

1. Tip magazine for receiving a plurality of identical tips (5) of a length L1 with a collar formed around the receiving opening, comprising a plane-parallel carrier plate (1) with a plurality of through-holes arranged in a predetermined two-dimensional grid, characterized in that a plane-parallel orienting plate (2) is provided which is oriented parallel to the carrier plate (1) at a distance L2 from the carrier plate (1), and in that the orienting plate (2) has the same quantity of through-holes in the same grid pattern as, and with a smaller cross section than, the through-holes of the carrier plate (1).

2. Tip magazine according to claim 1, characterized in that the thickness of the plates (1), (2) added to the distance (L2) is only slightly less than the overall length of the tips L1, excluding the collar width.

3. Tip magazine according to claim 1, characterized in that there are spacers (4) with a length L2 by which the carrier plate (1) and the orienting plate (2) are fixedly connected with one another.

4. Tip magazine according to claim 3, characterized in that there is a handle plate (3) which, in combination with the carrier plate (1) and the orienting plate (2), also serves as a spacer (4).

5. Tip magazine according to claim 3, characterized in that the spacers (4) are sleeves, each of which surrounds a through-hole of the carrier plate (1) and orienting plate (2).

6. Tip magazine according to claim 3, characterized in that the spacers (4) are rods, each of which is connected with the carrier plate (1) and the orienting plate (2) so as to be centered between four holes.

7. Tip magazine according to one of claims 3 to 5, characterized in that the spacers (4) communicate with the carrier plate (1) and the orienting plate (2) outside of the hole arrangements.

8. Tip magazine according to one of claims 1 to 7, characterized in that this tip magazine is an individual tip magazine for tips (5) of different shapes and dimensions due to the selection and combination of carrier plates (1) and orienting plates (2) with through-holes of different cross sections and sizes and a different spacing (L2).

9. Tip magazine according to one of claims 1 to 8, characterized in that the through-holes in the orienting plate (2) have a circular or rectangular cross section.
